(19) United States
(12) Patent Application Publication
(10) Pub. No.: US 2023/0113131 A1
(43) Pub. Date: Apr. 13, 2023

(54) Self-Supervised Learning of Photo Quality Using Implicitly Preferred Photos in Temporal Clusters

(71) Applicants: Shawn O'Banion, Mountain View, CA (US); Wenhuan WEI, Mountain View, CA (US); Yukun ZHU, Mountain View, CA (US); Google LLC, Mountain View, CA (US)

(72) Inventors: Shawn Ryan O'Banion, Seattle, WA (US); Wenhuan Wei, Seattle, WA (US); Yukun Zhu, Seattle, WA (US)

(21) Appl. No.: 17/909,579

(22) PCT Filed: Mar. 5, 2020
(86) PCT No.: PCT/US2020/021185

§ 371 Date: Sep. 6, 2022

(51) Int. Cl. G06V 20/70; G06V 10/98; G06V 10/771; G06V 10/75; G06V 10/74; G06V 10/82

(52) U.S. Cl. CPC G06V 20/70; G06V 10/993; G06V 10/771; G06V 10/751; G06V 10/761; G06V 10/82

(57) ABSTRACT

The present disclosure is directed to systems and methods for performing automated labeling of images. Labeled images can be used to train machine-learned models to infer image attributes such as quality for suggesting user actions.

### FIELD

The present disclosure relates generally to machine learning. More particularly, the present disclosure relates to self-supervised learning methods which can leverage implicit user signals indicative of image quality to automatically generate labeled training data for determining photo quality.

### BACKGROUND

The ubiquitous nature of cameras in everyday devices has led to ever increasing number of photographs and videos for storage. While users may have an initial interest in the photographs they take, over time this may decrease, and users may forget which photographs they preferred. Curating substantial numbers of photographs can be time consuming and may lead to issues where available storage conflicts with a current desire to take a new photograph.

Needed in the art are methods for learning photograph quality to improve suggestion or indication of photographs a user would prefer to store. While photograph quality models are available for features such as detecting whether eyes are open, these models are generally narrow in scope. Additionally, developing a generalized machine learning model using typical supervised learning techniques would require large scale acquisition and manual labelling of training data. Manual labelling of training data is time consuming, expensive, and ultimately may not truly reflect underlying user judgments regarding relative image quality.

### SUMMARY

The present disclosure is directed to systems and methods for performing automated labeling of images. Labeled images can be used to train machine-learned models to infer image attributes such as quality for suggesting user actions.

One example aspect of the present disclosure is directed to the automatic collection of training data (e.g., “ground truth labels”) by leveraging implicit user preferences to self-label temporal clusters of photos.

Another example aspect of the present disclosure is directed to grouping images into one or more clusters based at least in part on a time metric. Grouping the images can provide an initial assessment of photo similarity since photographers normally capture several images of the same scene. In this manner, the time metric can reduce the affect of user bias since implicit signals can be inferred for each image in a cluster rather than in images that display substantially different subject matter.

Another example aspect of the present disclosure is directed to determining a quality metric based on the one or more inferred implicit signals.

Generally, example implementations of the present disclosure include methods and systems for performing automated labeling of image data that can include computer executable operations for obtaining a plurality of images; grouping each image in the plurality of images into one or more clusters based at least in part on a time metric; and for at least one of the one or more clusters: obtaining one or more user signals descriptive of user actions relative to the images in the cluster; inferring a quality metric for at least one image in the cluster based at least in part on the one or more user signals descriptive of the user actions relative to the images in the cluster; generating a label for at least one image of the cluster based at least in part on the quality metrics determined for the images in the cluster; associating the label generated for the at least one image with the at least one image in the cluster; and storing the labeled images and the respective labels generated for the labeled images in a training dataset.

### BRIEF DESCRIPTION OF THE DRAWINGS

Detailed discussion of embodiments directed to one of ordinary skill in the art is set forth in the specification, which refers to the appended figures, in which:

FIG. 1A illustrates an example computing system including one or more machine-learned model(s) in accordance with example implementations of the present disclosure.

FIG. 1B illustrates an example computing device including one or more machine-learned models(s) in accordance with example implementations of the present disclosure.

FIG. 1C illustrates another example computing device including one or more machine-learned model(s) in accordance with example implementations of the present disclosure.

FIG. 2A illustrates an example flow process for determining quality metrics for a plurality of images according to example implementations of the present disclosure.

FIG. 2B illustrates an example flow process for generating labels based on the determined quality metrics according to example implementations of the present disclosure.

FIG. 2C illustrates an example flow process for associating labels to images according to example implementations of the present disclosure.

FIG. 3A illustrates a flow chart for training a machine-learned model according to example implementations of the present disclosure.

FIG. 3B illustrates an example process flow displaying a machine-learned model configured to receive an input including one or more images and generate an output including one or more labels according to example implementations of the present disclosure.

FIG. 4 illustrates a flow diagram depicting an example method for performing automated label generation according to example implementations of the present disclosure.

FIG. 5A illustrates photographs displaying an example of label generation according to example embodiments of the present disclosure. The figure depicts one image having a border (as an example label) for each group of three images to indicate the image as higher quality.

FIG. 5B illustrates photographs displaying another example of label generation according to example embodiments of the present disclosure. The figure shows one image having a border as an example label in each set of three images to indicate the image as higher quality.

FIG. 6 illustrates an example user device implementing an example machine-learned model according to example embodiments of the present disclosure. The user device can include one or more applications for image storage or acquisition that may transmit image data to the machine-learned model through an application programming interface (API). Output generated by the machine-learned model can also be used to adjust setting(s) for image display on the user device.

FIG. 7 illustrates an example framework for federated learning that can be applied to training personal machine-learned models according to example embodiments of the present disclosure.

Reference numerals that are repeated across plural figures are intended to identify the same features in various implementations.

### DETAILED DESCRIPTION

### Overview

In general, the present disclosure is directed to systems and methods for the automated generation of labeled image data based on implicit user signals that are indicative of image quality. For example, the implicit signals can be descriptive of user actions toward the images and can include data associated with the image and/or data associated with an application hosting the image. Examples of such associated data descriptive of user actions can include a number, type, frequency, or nature of user interactions (e.g., clicks, zooms, edits, likes, view time, and/or shares) with an image. The user actions may be actions that do not provide an explicit label for any of the images. Based on these implicit signals, a computing system can infer a quality metric for one or more images which are included in an image cluster. The computing system can automatically generate and apply a training label to one or more of the images in the cluster based on the inferred quality metric. The training data generated by this process can be used to train a machine-learned model. As one example, a model can be trained on the training data to select a “best” image from a cluster of images. As such, the labeled image data can be used to train machine-learned models to infer a subjective characteristic, such as photo quality or desirability, while the labels were generated based on objective metrics such as the number, type, frequency, or nature of user interactions with an image.

Thus, the present disclosure proposes techniques for the automatic collection of training data (e.g., “ground truth labels”) by leveraging implicit user preferences to self-label temporal clusters of photos. Examples of these user preferences include dwell time, number of times the photo has been viewed, whether the photo was shared, whether it was “favorited”, etc. The temporal clustering aspect ensures that the content of the photos are similar (e.g., but not identical), which allows for control of other variables that may influence a user's preference for those photos. Once completed, the data can be used to train self-supervised models that can then be applied to other, non-labeled photos to predict their quality. As such, no human labeling/annotation is required and therefore the proposed techniques are quite scalable, efficient, and inexpensive.

More particularly, to account for differences in subject matter and/or personal preferences, photo quality can be learned based on clustering photos into one or more temporal clusters. The temporal clusters can be defined to include images that were taken within a certain timespan (e.g., within 1, 2, 3, 4, 5, 6, 7, 8, 9, 10, or a time greater than 10 seconds). In other examples, the clusters can be based on similar image content and/or shared location (e.g., as provided by EXIF data) or can be generated through any number of existing clustering algorithms (e.g., time-based clustering algorithms). In this manner, the images in each temporal cluster generally include the same subject matter and/or scenery but may differ due to involuntary movements (e.g., a sneeze or blink), change in position/orientation, or other subtle changes in the scene being captured. A time metric, such as the timespan, can provide an initial filter for image and/or subject matter similarity. In some instances, implementations according to the present disclosure can also include a machine-learned model configured to determine a similarity metric based on receipt of two images. This additional machine-learned model can provide a second filter for large datasets that may include images taken by different devices of different scenes that are associated with similar timestamps.

As an example for illustration, many cameras now feature an option for capturing burst photos. A burst photo generally includes a short video (e.g., about 1 second) capturing a series of image frames. Each of the image frames in a burst is taken automatically but may vary due to slight adjustments of the subject matter such as involuntary movements or other actions. More particularly, a burst photo of a group or a portrait may capture a person blinking, looking away from the camera, talking, or other actions signaling that the person was not ready to be photographed. While machine-learned models can be trained from this corpus of data, manual labeling can be expensive and time-consuming. Instead, implementations according to the present disclosure seek to use implicit signals that users can generate. For instance, most users generally review photographs after they are taken and may signal a preference based on the time spent viewing one image frame, the number of times accessing one of the image frames, the number of times sharing (e.g., by text, social media, or both) one image frame, or similar metrics. Each burst photo can be considered a temporal cluster and each image frame can be associated with one of more of these preferences which collectively can be considered quality metrics. While exemplified using a burst photo, it should be understood that other image sets can be grouped into one or more clusters using a time metric.

For some implementations, the quality metrics can define one or more quantitative values that can be used to generate image labels. For instance, a cluster (e.g., a burst photo) may include one image that was shared 10 times, a second image that was shared twice and, 12 images that were not shared. These quantitative values can be used to train a machine-learned model to regress these values and/or values for other quality metrics. Additionally or alternatively, the quality metrics can be grouped for each cluster to determine a population label. From this data a population of share counts can be determined for each image in the cluster. The population of counts can be used to define a statistic such as percentiles that can be used to assign labels such as upper quartile, middle quartiles, and lower quartile to the respective image frames. Images associated with upper quartile labels can be interpreted as displaying higher quality compared to images associated with middle quartile or lower quartile labels. In this manner, qualitative labels can be assigned to image frames in a cluster (e.g. a burst photo). Further, certain implementations can be configured to determine a binary label (e.g., optimal quality or less optimal quality) designating one image frame in the temporal cluster as optimal quality and any other image frame in the temporal cluster as less than optimal quality.

One example implementation according to the present disclosure includes a method for automated labeling of images. Aspects of the method can include obtaining, by one or more computing devices, a plurality of images; grouping each image in the plurality of images into one or more clusters based at least in part on a time metric; determining a quality metric for each image in the cluster; and generating a label for each image based at least in part on the quality metric determined for each image grouped in one cluster for each of the one or more clusters.

In some example implementations, the method for the automated labeling of images can be used to produce training data for a training a machine-leaning model. For instance, certain implementations can include steps for associating the label generated for each image with each image in the cluster, and storing, by the computing devices, the plurality of images and the respective label generated for each image in a training dataset.

Further, for certain example implementations, the method can also include steps for training a machine-learning model using the training dataset generated according to other example implementations. In some implementations, training the machine-learning model can be limited to only using a training dataset that does not include any human-labeled ground truth. Thus, automated labeling pipelines according to the present disclosure can generate machine-learning datasets without the need for any human labelers which can provide advantages and both cost and the time needed to produce training data.

After training, the machine-learned model can be configured to send information to adjust a device state and/or a device policy for certain applications via an application programming interface. As one example, the machine-learned model can be configured to output value(s) (e.g., a numerical quality value) for image(s) based on receiving one or more image frames. Based at least in part on the value(s), an attribute of the one or more image frames (e.g., a default image size, an image order, a default image, storage handling, surfacing responsive to searching, or combinations thereof) can be adjusted. For instance, including the machine-learned model on a user device such as a smartphone can enable the model to communicate with on-device applications (apps) such as image storage, image searching, or acquisition apps. In certain implementations, the machine-learned model can be enabled to receive or otherwise access image frames included in an image storage app, and, based on model output, adjust one or more attributes of the image frames in the image storage app. After adjusting the one or more attributes, a user accessing application data can view the adjustment (e.g., using a user interface). For instance, a machine-learned model according to the present disclosure may determine labels for a photo library on a smartphone. Based on the labels, default sizes for photos included in the photo library may be adjusted (e.g., photos associated with higher quality metrics can be larger and photos associated with lower quality metrics can be lower) so that a user reviewing the photo library automatically views different size thumbnails of image frames when accessing the photo library.

As another example, implementations according to the present disclosure can be used to train a machine-learned model for photo suggestion. For instance, including the machine-learned model on a user device can enable the model to communicate with an on-device application for image acquisition such as a camera. Upon taking a photograph or series of photographs, the machine-learned model can generate a label such as a quality score. Based on the quality score, the device can include instructions for determining a device state or device policy. The device state or device policy can be used to determine a system response, such as accessing data from another application or from device memory. For instance, a natural language response can be determined by the system for suggesting sharing the photograph (e.g., “Send this photo to Lori?”). Alternatively, the natural language response can be determined by the system for suggesting deleting or retaking the photograph (e.g., “Image quality low, would you like to retake?”). Thus, based on a quality score or label, implementations according to the present disclosure may determine a system response to improve user experience by organizing image data and/or suggesting an action based on aspects of image data.

As a further example, implementations according to the present disclosure can be used to train a machine-learned model for photo album management. Digital photo albums stored, for example, an image storage app on a device often include sequences of images captured in close temporal proximity, such as images captured manually in quick succession or using a burst photo. Such sequences of images may contain a high degree of redundancy, while consuming large amounts of memory resources. The machine-learned model can be applied to these sequences of images to generate a label such as a quality score. Based on the quality score, the device can select one or more images to retain, and delete the other images in the sequence/suggest deletion of the other images in the sequence. For example, the device may select the highest scoring image in a sequence or one or more images with a quality score above a threshold score to retain. In this manner, the machine learning model can be used to automatically prune a photo album, reducing its memory consumption while retaining the highest quality images in each sequence of images.

One example aspect of implementations according to the present disclosure includes determining a quality metric for each image in at least one of the clusters. In particular, determining the quality metric can include obtaining one or more user signals descriptive of user actions relative to the images in the cluster, and inferring the quality metric for at least one image in the cluster based at least in part on values for the one or more user signals descriptive of the user actions relative to the images in the cluster. For instance, determining the quality metric can include obtaining data descriptive of user interactions such as accessing image data (e.g., number of accesses, time accessing the image, etc.), modifying image data (e.g., editing, deleting, favoriting, etc.), transmitting image data (e.g., uploading an image to an application, sending an image to a friend, etc.), or other information associated with the image file on one or more applications. Additionally, inferring the quality metric can include a basis such as selecting one or more types of user interactions. In some implementations, the basis can include selecting one user interaction that has a non-zero value for each image in the cluster. Alternatively, in certain implementations, the basis can include selecting a set of user interactions (e.g., two, three, or more than three interactions) and summing the values for each interaction to generate the quality metric. For certain implementations, the basis can also include weighting the values of interactions before summing the values. Thus, in general, inferring the quality metric includes aggregating values for implicit user signals or interactions associated with each image in the cluster.

Another example aspect of implementations according to the present disclosure can include training the machine-learned model using a federated learning framework. Federated learning can be used to protect sensitive data by maintaining image data or other related data on a local device rather than storing this data remotely (e.g., on a server). Using federated learning can provide benefits in training models at scale using a variety of data and aggregating the training results to train a single generalized model. Thus for certain implementations, training the machine-learning model can include transmitting a personal machine-learning model to one or more user devices and generating a set of training results for each of the one or more user devices by training the personal machine-learning model using images obtained by the user device associated with the personal machine-learning model. Each personal machine-learning model can include or have access to instructions for automated labeling of images on the user device in accordance with example implementations.

After training each personal machine-learning model, training results (e.g., weights) can be aggregated and/or shared between the personal machine-learning models until meeting a convergence, a number of training rounds, or both. Further, the architecture of each personal machine-learning model can be adjusted between training rounds. For instance, artificial neural network models can increase or decrease the number of hidden layers, the number of nodes, the connectivity between nodes, or other parameters related to the model architecture.

With reference now to the Figures, example embodiments of the present disclosure are discussed in further detail.

### Example Devices and Systems

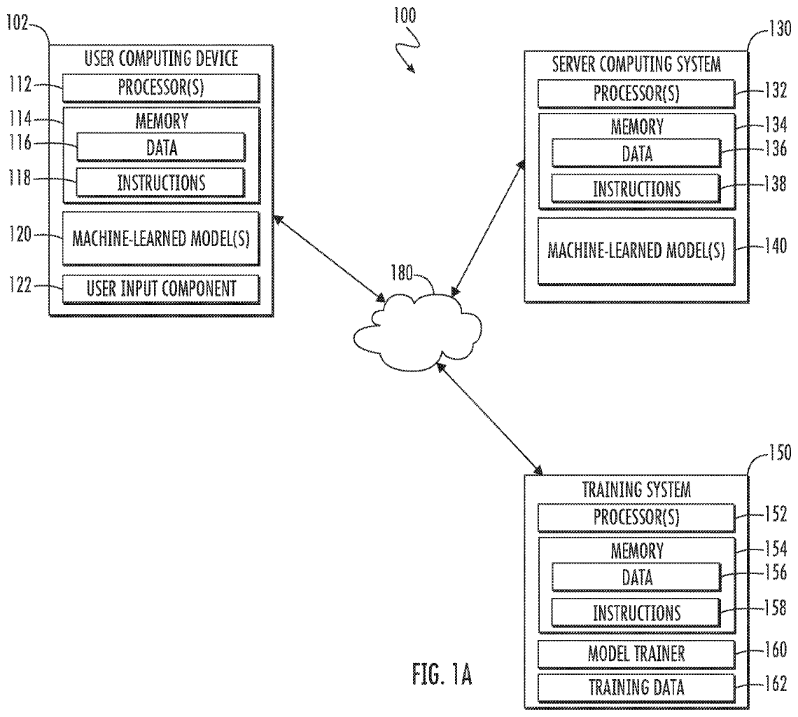

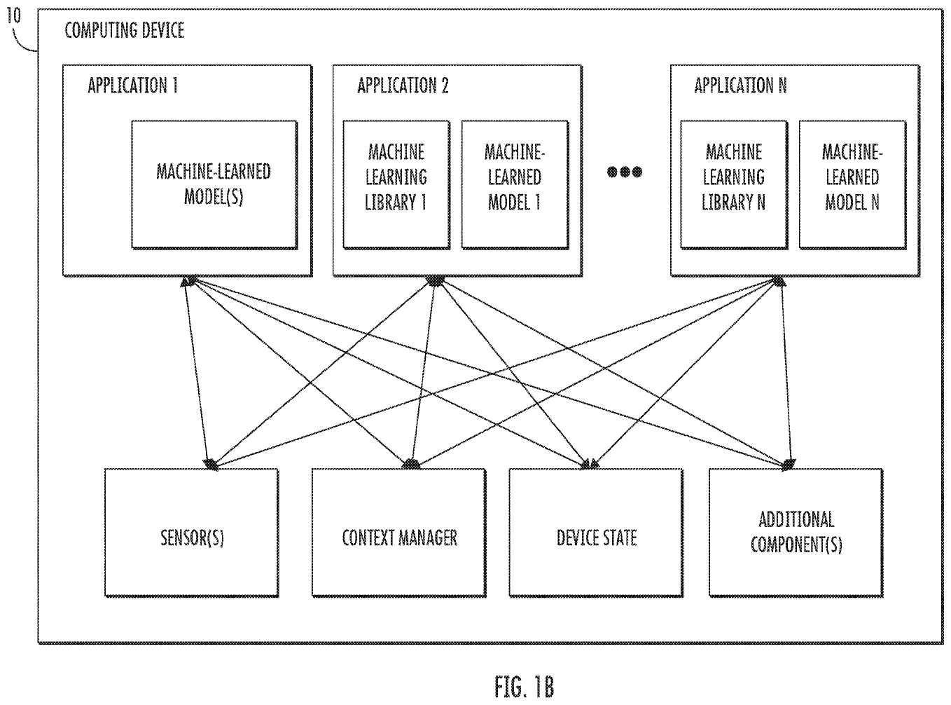

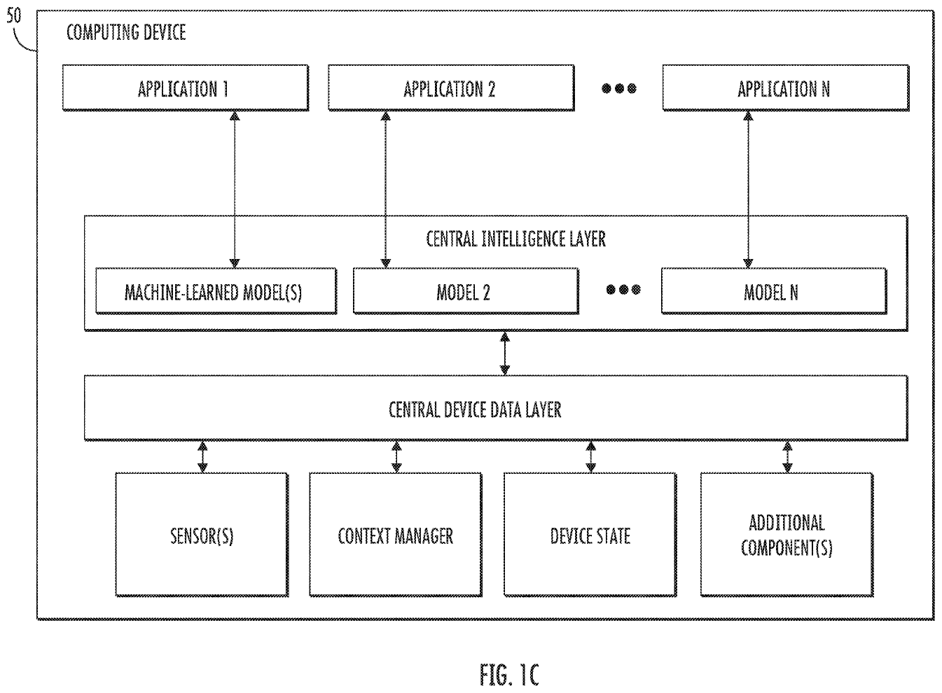

FIG. 1A depicts a block diagram of an example computing system 100 that can store or transmit information such as machine-learned models 120 or 140 and/or instructions 118 or 138 for performing automated label generation for training said machine-learned models 120 or 140 according to example aspects of the present disclosure. In one example implementation, the system 100 can include a user computing device 102 and a server computing system 130 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 can include one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations such as automated label generation.

In some implementations, the user computing device 102 can store or include the machine-learned model(s) such as a classifier (e.g., a multi-label classifier, a binary classifier, etc.), a regression model or other machine-learned models having model architectures according to example implementations of the present disclosure.

In certain implementations, the machine learned model(s) 120 can be received from the server computing system 130 over network 180, stored in the user computing device memory 114, and then used or otherwise implemented by the one or more processors 112. In some implementations, the user computing device 102 can implement multiple parallel instances of a single machine-learned model (e.g., to perform parallel labeling for large corpora of images).

Additionally or alternatively, the machine-learned model(s) 140 can be included in or otherwise stored and implemented by the server computing system 130 that communicates with the user computing device 102 according to a client-server relationship. For example, the machine-learned model(s) 140 can be implemented by the server computing system 130 as a portion of a web service. Thus, the machine-learned model(s) 120 can be stored and implemented at the user computing device 102 and/or machine learned model(s) 140 can be stored and implemented at the server computing system 130.

Since implementations according to the present disclosure can include methods for generating training data for training machine-learned model(s) one example aspect of computing systems 100 can include a training system 150 in communication with the user computing device and/or the server computing system 130. The training system 150 can include instructions 158 for generating training data 162 that can be implemented using a model trainer 160. Alternatively or additionally, the user computing device 102 and/or the server computing system 130 can include instructions for generating training data that can be stored in local memory 114 or remote memory 134 and does not necessarily need to be stored as part of the training system 150.

As illustrated in FIG. 1A, in certain implementations the training system 150 can be separate from the user computing device 102 and/or the server computing system 130. Alternatively, in some implementations the training system 150 can be integrated or otherwise included as part of the user computing device 102, the server computing system 130, or both. Thus, while illustrated separately in FIG. 1A, it should be understood that instructions 118 138 158 and/or other attributes (e.g., data 116) of the user computing device 102, the server computing system 130, and the training system 150 can be co-located and are not limited to multiple devices and/or systems. As one example, a computing system according to the present disclosure can include a single computing device having one or more processors 112 and memory 114 containing instructions 118 for generating labeled image data that can be used as training data 162 to generate one or more machine-learned model(s).

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard, user interface, or other tool for receiving a user interaction. Other example user input components can include a microphone, a camera, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include machine learned model(s) 140, instructions 138 for generated labeled image data, or both. Example machine-learned models include neural networks or other multi-layer non-linear models. Example neural networks include feed forward neural networks, deep neural networks, recurrent neural networks, and convolutional neural networks.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well.

FIG. 1B illustrates an example computing device 10 including one or more machine-learned models in accordance with the present disclosure. Each of these machine-learned model(s) can be associated with an application such as classification, image similarity, or others described herein. Each machine-learned model can be trained using a machine learning library that can include labeled data for performing supervised and/or unsupervised training tasks. As one example, one machine-learned model may be configured to determine a label based on receiving an image. This machine learning library can include images that have been labeled based on a quality metric. Further the machine learning library can include labeling data that can be generated on the device using an automated pipeline.

In certain implementations the machine-learned model(s) and/or automated labeling pipeline can be in communication with other components of the computing device such as sensor(s) (e.g., a camera), a context manager, a device state, or other additional components. For instance, an API can be configured to support communication between a device component such as a camera so that data can be directly sent to the machine-learned model(s) and/or the labeling pipeline.

FIG. 1C illustrates another example computing device 50. The example computing device 50 can include one or more machine-learned models for inferring image quality according to example implementations of the present disclosure.

### Example Data Pipeline and Labeling

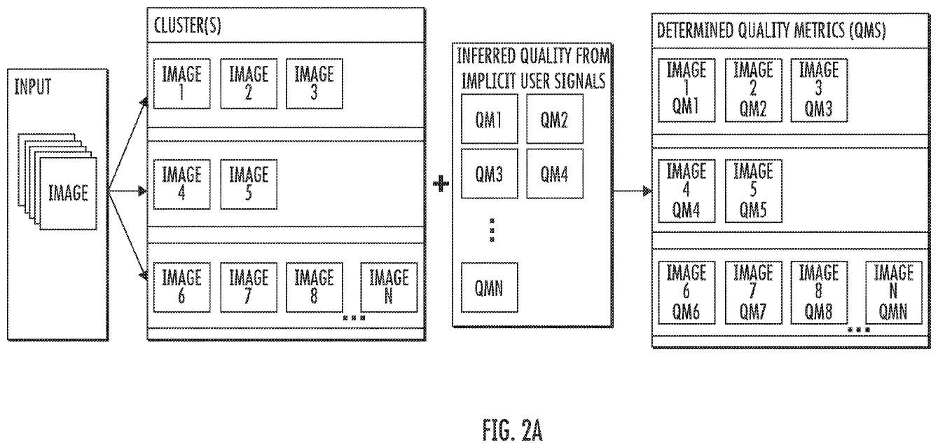

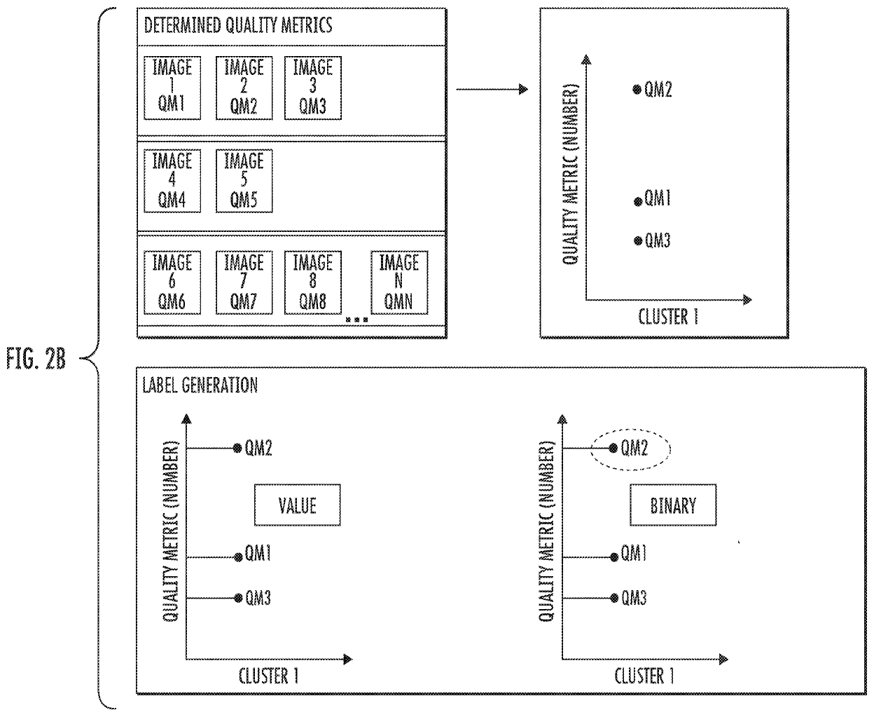

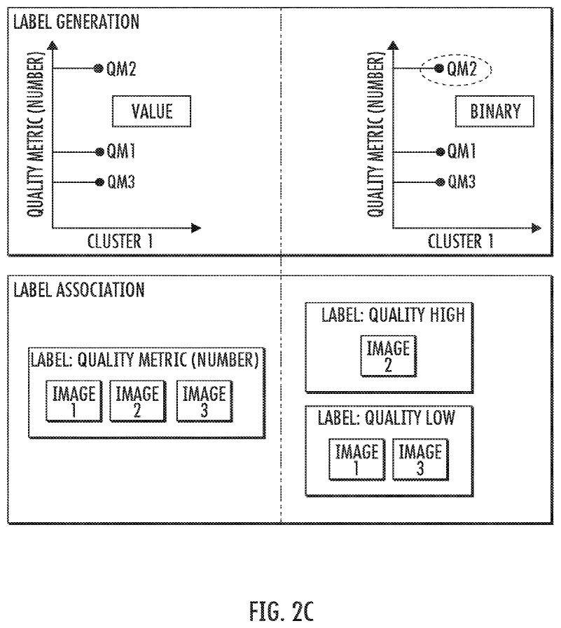

FIGS. 2A-2C depict an example data pipeline for automated labeling of images. FIG. 2A depicts an input that includes a plurality of images which can be accessed or otherwise obtained by an example computing system. The input can be grouped into one or more clusters based on a time and/or location metric associated with the images. For example, each image frame in the plurality of images may be associated with a metadata file or another file type storing properties related to the image such as a date and/or timestamp. In some implementations, the date and/or timestamp can be used to determine a time metric such that each cluster includes only images having a timestamp within a predetermined timespan. The predetermined timespan can range from between about 1.0 seconds to about 60 seconds such as 2.0 seconds to about 50 seconds, between about 3.0 seconds to about 45 seconds, between about 5.0 seconds to about 30 seconds, between about 10 seconds to about 25 seconds, or about between about 18 seconds to about 22 seconds. Alternatively or additionally, the time metric can exclude images having a timestamp greater than a time threshold from the average timestamp. As one example, standard deviation can be used to measure the variation between values in a group. Thus, a time metric can also be defined such that that the standard deviation for the timestamps for each image in the cluster is about 1.0 or less.

As shown in FIG. 2A, each cluster can contain one or more images (e.g., images 1-3, images 4 and 5, and images 6-8 . . . N). Each image can be associated with data related to image quality such as time spent viewing the image, the number of times accessing the image, the number of times sharing (e.g., by text, social media, or both) the frame. Alternatively or additionally, systems and methods may include instructions for obtaining data related to image quality. This associated data can be referred to as quality metrics (QM) one or more of which can be determined for each of the images in each of the clusters. Thus, each of QM1, QM2, QM3, . . . QMN can include quantitative values for one or more quality metrics.

As shown in FIG. 2B, the determined quality metrics can be organized by tracking each quality metric as an axis. For some implementations, the label associated with the image can be defined by a vector of quality metric values. Alternatively or additionally, the label associated with the image can be defined based on a population statistic determined for each cluster. For instance, QM2, QM4, and QM8 are all circled as each of these quality metrics demonstrates an optimum value for each cluster. Thus, even though QM8 has the highest overall quality metric value, image clustering can result in each cluster determining a label for an optimum image.

FIG. 2C further illustrates this labeling structure. In FIG. 2C, the associated label can be based on the value of the quality metric as shown on the left. The associated label can also be based on a population value determined for the cluster such as a maximum, a minimum, percentiles, or other population groupings. For instance, FIG. 2C displays an example of binary labeling where one image from each cluster can be assigned a high quality label based on displaying a maximum population value and all other labels in the cluster are assigned low quality labels.

### Example Model Training and Applications

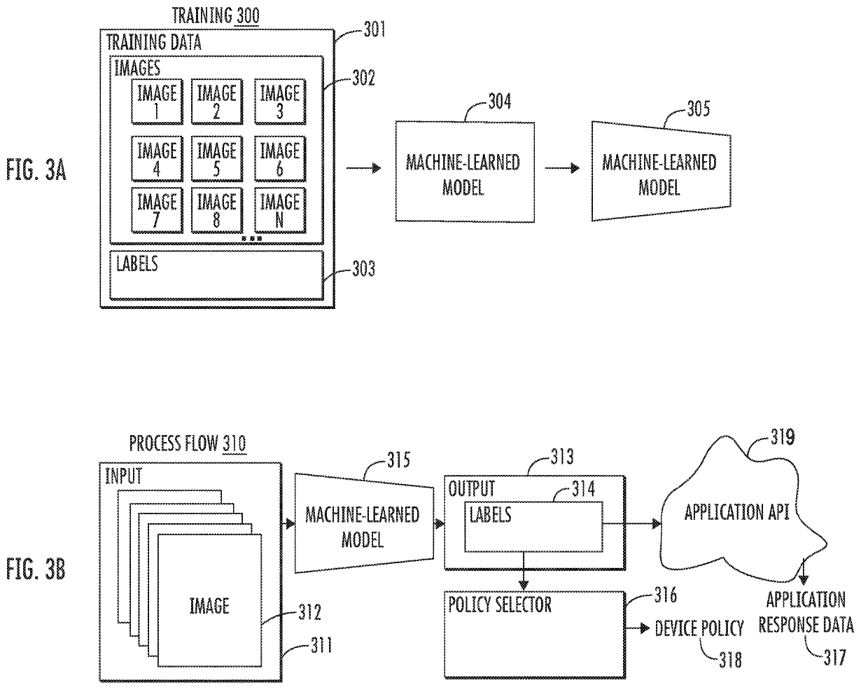

FIG. 3A illustrates an example framework for training 300 a machine-learning model to produce a machine-learned model according to the present disclosure. In FIG. 3A, the training data 301 can include a plurality of images 302 (images 1-8, . . . N) and associated labels 303. The images 302 and associated labels 303 can be generated using automated labeling and for some implementations may include additional information such as cluster groupings. Training the machine-learning model 304 can utilize a variety of techniques including supervised, semi-supervised and unsupervised learning algorithms. Additionally, the machine-learning model 304 can be configured to have an architecture such as a neural network including one or more hidden layers. After training, a set of parameters can be associated with the machine learning model 304 go produce a machine-learned model 305 in accordance with the present disclosure. As an example, the machine-learned model 305 can be configured to determine a label based on the receipt of image data.

FIG. 3B illustrates an example process flow 310 for using a machine-learned model 315 to generate output 313 including labels 314 based on receiving an input 311 including a plurality of images 312. As shown, these labels 314 can be transmitted to on-device or external applications via communication with an application API 319 and/or a policy selector 316. The application API 319 can be configured to process the labels to generate response data 317 such as indicating a change in one or more settings. Additionally or alternatively, the policy selector 316 can be configured to process the labels to generate a device policy 318 such as a prompt questioning whether an image associated with one or more of the images 312 associated with the labels 314 should be deleted or shared. Device policy 318 can also include a rate of image capture, whether a captured image is stored, and/or other controls regarding device behavior and/or image handling.

### Example Methods

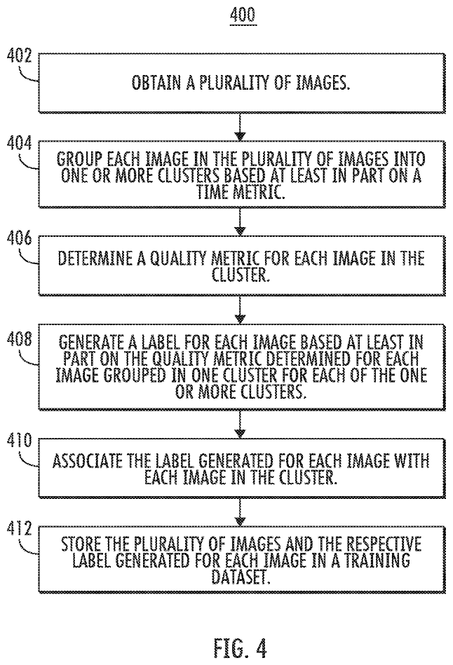

FIG. 4 depicts a flow chart diagram of an example method for automated label generation according to example implementations of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, a computing system can obtain a plurality of images. Obtaining the plurality of images can include accessing a database of stored image data, generating one or more images using a device such as a camera that can be included in the computing system or that can be in communication with the computing system, or both.

At 404, the computing system can group each image in the plurality of images into one or more clusters based at least in part on a time metric. More particularly, each image in the plurality of images can be associated with a timestamp or other data indicative of a time, date, and/or place indicating where and/or when the image was created. For certain implementations the time metric can define a timespan that all images within a cluster must be within (e.g., all images within a cluster must have timestamps within 30 seconds of each other. Alternatively, the time metric can be defined relative to a population value determined from each image included in the culture. For example, the time metric can also be defined such that that the standard deviation for the timestamps for each image in the cluster is about 1.0 or less. Thus, the time metric can be generally defined as a time value (e.g., timestamp) that can be extracted from each image in the cluster, that must meet a condition for the cluster (e.g., timespan, standard deviation, etc.)

At 406, the computing system can determine a quality metric for each image in the cluster. More particularly, determining the quality metric can include accessing data associated with each image or with one or more applications hosting each image. This associated data can include numerical values for a number of likes, a number of shares, a number of views, a time viewed, an edit, a deletion, or any combination thereof. In some implementations, the quality metric can be limited to only a single metric. Alternatively, for certain implementations the quality metric can include one or more metrics.

At 408, the computing system can generate a label for each image based at least in part on the quality metric determined for each image grouped in one cluster for each of the one or more clusters. Aspects of generating the label for each image can include a labeling scheme. As an example, the quality metrics can define one or more quantitative values that can be applied as image labels. For instance, the numeric value of one or more quality metrics can be used to determine a scalar, vector, or tuple (e.g., using regression) as one example of a label. Additionally or alternatively, the quality metrics can be grouped in each cluster to determine a population label. From this data a population of quality metrics (e.g., share counts) can be determined for each image in the cluster. The population of counts can be used to define a statistic such as percentiles that can be used to assign labels such as upper quartile, middle quartiles, and lower quartile to the respective image frames. Images associated with upper quartile labels can be inferred as displaying higher quality compared to images associated with middle quartile or lower quartile labels. In this manner, qualitative labels can be assigned to image frames in a cluster. Further, certain implementations can be configured to determine a binary label (e.g., optimal quality or less optimal quality) designating one image frame in the temporal cluster as optimal quality and any other image frame in the cluster as less than optimal quality.

At 410, the computing system can associate the label generated for each image with each image in the cluster. As one example, the label generated for each image can be referenced to the respective image using a database reference and/or metadata embedded in the image or associated with a separate file.

At 412, the computing system can store the plurality of images and the respective label generated for each image in a training dataset. For certain implementations the training dataset can be stored on a local device and not transmitted to a remote device or server. For example, in some implementations, a federated learning scheme can be used to train a group of personal machine-learning models on image data from a plurality of user devices. In this manner, a training dataset can be generated for each user device and used to train the personal machine-learning model. Training results such as weights or other attributes of the personal machine-learned model can then be transmitted to a global model for subsequent processing such as aggregation across training results for each of the personal machine-learned models.

From at least the combination of operations described in FIG. 4, computing systems according to the present disclosure can perform automated labeling of images as well as train and machine-learned model to infer image quality.

### Example Label Generation

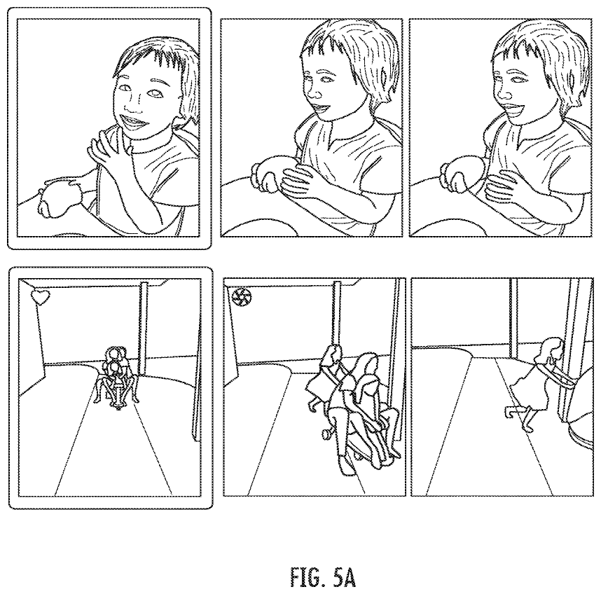

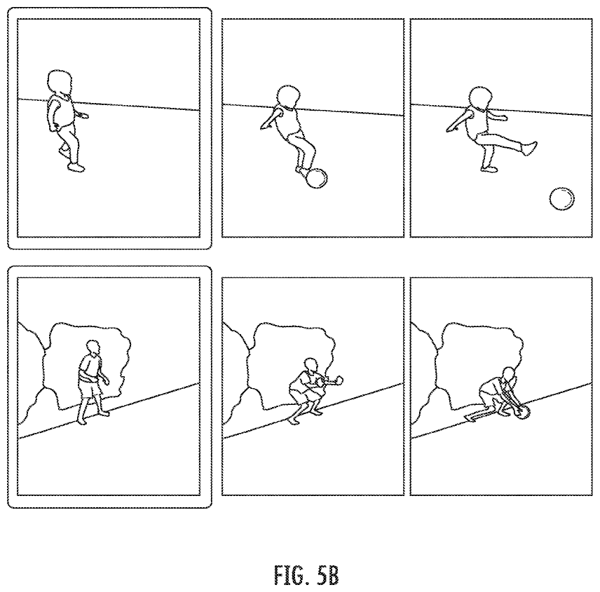

FIGS. 5A and 5B illustrate imagery of photographs depicting example label generation according to example implementations of the present disclosure. As shown in FIG. 5A a set of six images can be grouped into two clusters based on a time metric. The first set of images (upper 3) can include inherent attributes that can be extracted from the image or may be associated with the image. For example, the first image highlighted by the border may have been shared or the user may have viewed it multiple times compared to the second and third images. Similarly, the second set of images (lower 3) can also include attributes such as one of the images having a liked status or edit status as indicated by the inset. Based at least in part on the inherent attributes, a label can be generated to indicate image quality (e.g., a liked image can be highlighted by a border to indicate higher image quality).

FIG. 5B also displays a set of six images grouped into clusters according to example implementations of the disclosure. Based on the groupings a label can be generated and associated with one or more images in the cluster to indicate an attribute such as image quality. FIG. 5B also displays a border to indicate higher image quality for each cluster. As shown in FIGS. 5A and 5B, imagery in each of the clusters is highly similar and which can reduce the effect of personal bias in quality metrics used to determine the label.

### Self-Supervised Learning

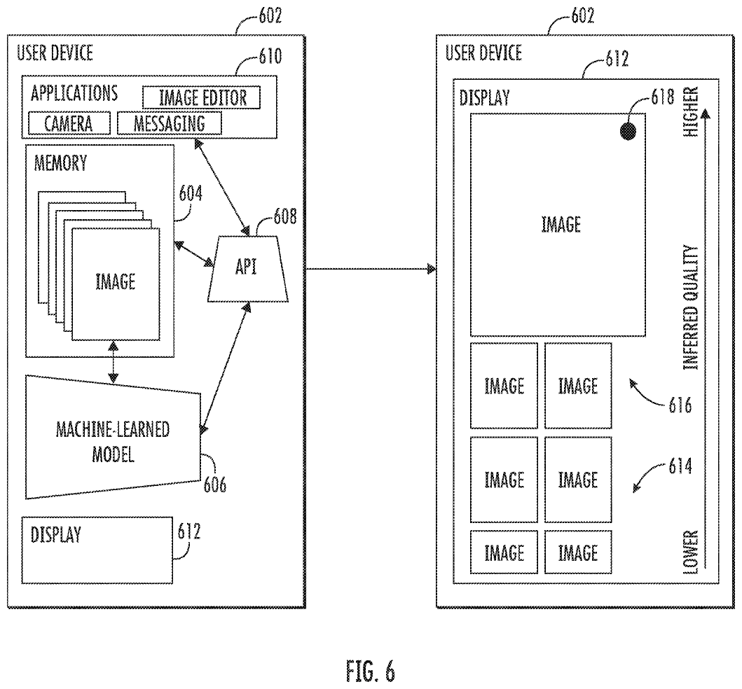

FIG. 6 illustrates an example embodiment of self-supervised learning for certain implementations according to the present disclosure. As depicted, a user device 602 can include memory 604 storing a plurality of images that can be accessed by a machine-learned model 606 trained to determine labels indicative of image quality. The model output can be provided to an API 608 configured to communicate with one or more applications 610 associated with the user device such as a camera, an image editor, a messenger or notification service, and other applications. Based on the API response and/or device policy, the model output can be applied to adjust configurations for one of the user device 602 applications 610 such as an image storage, display, and/or editing application. As an example for illustration, the adjusted configurations can result in one of the applications 610 providing for display on a display 612 of the user device 602 images according to size parameters determined based in part on the labels. For instance, images associated with lower quality labels 614 can be displayed smaller than images associated with higher or high-quality labels 616. Additionally, suggested photos may include a label or other indicator 618 displayed on or near the image.

User responses to the updated images can lead to changes in quality metrics associated with the images which may be used to perform retraining of the model(s). For instance, after adjusting the configuration, the machine-learned model may be retrained using new training data generated from the updated images. Thus, certain implementations can include further accessing or otherwise updating the quality metrics determined for each image in each cluster and, based at least in part on the updated quality metrics, generating a new label for each image in the cluster.

### Federated Learning

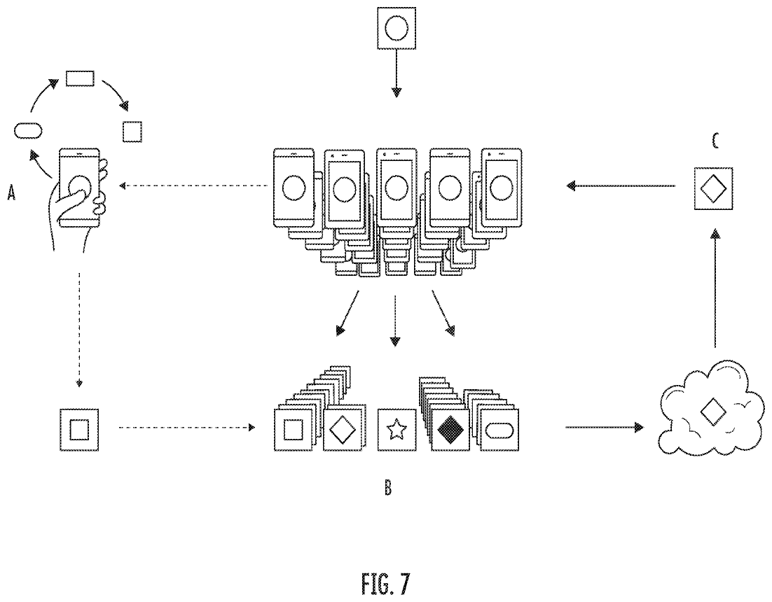

FIG. 7 depicts an example implementation of federated learning that can be applied to certain implementations according to the present disclosure. As illustrated, a personal machine-learning model (e.g., a current global model) can be obtained by a plurality of individual devices (e.g., a plurality of user devices) along with instructions for implementing an automated labeling pipeline as illustrated by the circle icon transferring to a multitude of device screens. If the device opts into using the technology (see step A), the automated labeling pipeline can access user data from applications for image storage, image hosting, image sharing, or other applications which store data associated with images on the device. The images and image data can then be used to generate training data according to example implementations of the disclosure and the training data used to generate a personal machine-learned model (e.g., update the current global model) by training the personal machine-learning model.

The personal machine-learned model can be associated with training results such as weights, activation functions, or other parameters associated with the machine-learned model. Since each device will likely include a variety of different images, each device will generate unique training results (see step B). These training results can be transmitted to a remote device such as a server or cloud service which may aggregate or otherwise transform the training results, thereby updating the global model. Using this information, an updated version of the global machine-learning model (see step C) can be transmitted to the plurality of devices and the training process repeated. Aspects of the updated machine-learning model can include an updated parameter values related to the model. Participation in such a federated learning scheme can enable an improved global model without any of the user's images or data regarding user actions leaving the user's device, thereby providing improved privacy.

### Additional Disclosure

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for automated labeling of images based on implicit user signals indicative of image quality, the method comprising:
obtaining, by one or more computing devices, a plurality of images;
grouping, by the one or more computing devices, each image in the plurality of images into one or more clusters based at least in part on a time metric; and
for at least one of the one or more clusters:
obtaining, by the one or more computing devices, one or more user signals descriptive of one or more user actions relative to one or more of the images in the cluster;
inferring, by the one or more computing devices, a quality metric for at least one image in the cluster based at least in part on the one or more user signals descriptive of the user actions relative to the images in the cluster;
generating, by the one or more computing devices, a label for at least one image of the cluster based at least in part on the quality metrics determined for the images in the cluster;
associating, by the one or more computing devices, the label generated for the at least one image with the at least one image in the cluster; and
storing, by the one or more computing devices, the labeled images and the respective labels generated for the labeled images in a training dataset.

2. The computer-implemented method of claim 1, wherein the one or more user signals descriptive of user actions relative to the images in the cluster comprise user dwell data that indicates an aggregate dwell time of a user on one or more of the images in the cluster.

3. The computer-implemented method of claim 1, wherein the one or more user signals descriptive of user actions relative to the images in the cluster comprise user viewing data that indicates a number of times each image has been viewed by a user.

4. The computer-implemented method of claim 1, wherein the one or more user signals descriptive of user actions relative to the images in the cluster comprise user interaction data that indicates a number of times a user has interacted with each image via physical user input controls.

5. The computer-implemented method of claim 1, wherein the one or more user signals descriptive of user actions relative to the images in the cluster comprise user sharing data that indicates a number of times each image has been shared by a user.

6. The computer-implemented method of claim 1, wherein the one or more user signals descriptive of user actions relative to the images in the cluster comprise user favoriting data that indicates a number of times each image has been favorited by a user.

7. The computer-implemented method of claim 1, wherein generating, by the one or more computing devices, the label for the at least one image of the cluster based at least in part on the quality metrics determined for the images in the cluster comprises:
identifying, by the one or more computing devices based at least in part on the quality metrics, a first set of images from the cluster that have superior quality to a second, different set of images from the cluster;
labelling, by the one or more computing devices, the first set of images with a first label; and
labelling, by the one or more computing devices, the second set of images with a second, different label.

8. The computer-implemented method of claim 1, further comprising:
training, by the one or more computing devices and using a learning technique, a machine-learned model on the training dataset.

9. The computer-implemented method of claim 8, wherein the machine-learned model is trained to select one or more superior quality images from a sequence of input images.

10. The computer-implemented method of claim 1, wherein the training dataset does not include ground truth data labeled by a human.

11. The computer implemented method of claim 1, wherein grouping, by the one or more computing devices, each image in the plurality of images into one or more clusters comprises:
identifying, by the one or more computing devices, a timestamp associated with each image; and
selecting, by the one or more computing devices, images from the plurality of images to include in each of the one or more clusters such that the timestamp associated with each image within each cluster is within a timespan.

12. The computer-implemented method of claim 11, wherein the plurality of images consists substantially of one or more burst image sets, and wherein each of the one or more burst image sets comprise a video sequence of image frames, and wherein the timestamp associated with each image frame in the video sequence is within the timespan.

13. The computer implemented method of claim 1, wherein the quality metric comprises data descriptive of an interaction with the image.

14. The computer-implemented method of claim 13, wherein the interaction comprises one or more of: a number of likes, a number of shares, a number of views, a time viewed, an edit, a deletion, or any combination thereof.

15. The computer-implemented method of claim 8, wherein training, by the one or more computing devices and using a learning technique, the machine-learned model on the training dataset comprises participating in a federated learning framework, and wherein participating in the federated learning framework comprises:
training or retraining a local model based at least in part on the training dataset; and
providing data descriptive of a model update from training or retraining the local model to a central computing system for aggregation with model updates from other users.

16. The computer-implemented method of claim 1, wherein grouping, by the one or more computing devices, each image into one or more clusters comprises:
determining, by the one or more computing devices, a representative image for each cluster;
selecting, by the one or more computing devices, a set of images from the plurality of images based in part on the time metric, wherein each image in the set of images meets a threshold of the time metric; and
comparing, by the one or more computing devices, each image in the set of images to the representative image.

17. The computer-implemented method of claim 16, wherein comparing, by the one or more computing devices, each image in the set of images to the representative image comprises:
determining, by the one or more computing devices and using a machine-learned model configured to generate a similarity score between two images, similarity scores for each image in the set of images; and
adding, by the one or more computing devices, any images determined to have similarity scores meeting a threshold value to the cluster associated with the representative image.

18. The computer-implemented method of claim 1, wherein generating, by the one or more computing devices, the label for each image based at least in part on the quality metric determined for each image in the cluster comprises:
creating, by the one or more computing devices, a distribution of the quality metrics determined for each image in one of the one or more clusters;
selecting, by the one or more computing devices, and based at least in part on the distribution, an optimum image from said images in the one cluster; and
associating, by the one or more computing devices, the optimum image with a first label and any other images in the one cluster with a second label.

19. The computer-implemented method of claim 1, wherein obtaining, by the one or more computing devices, the plurality of images comprises:
obtaining, by the one or more computing devices, a respective property dataset associated with one or more of the plurality of images, wherein the respective property dataset for each image comprises one or more of: a time the image was taken, a date the image was taken, a place the image was taken, a number of times the image was accessed, a number of times the image was shared, or combinations thereof.

20. The computer-implemented method of claim 1, wherein obtaining, by the one or more computing devices, the plurality of images comprises:
accessing, by the one or more computing devices, an application configured to process image data on a user device; and
enabling, by the one or more computing devices and via an application programming interface, the application to transmit data to a data labeling application configured to determine the quality metric.

21. A computing system comprising:
one or more computing devices; and
one or more non-transitory computer readable media that collectively store instructions that, when executed by the one or more computing devices, cause the one or more computing devices to perform operations, the operations comprising:
obtaining, by one or more computing devices, a plurality of images;
grouping, by the one or more computing devices, each image in the plurality of images into one or more clusters based at least in part on a time metric; and
for at least one of the one or more clusters:
obtaining, by the one or more computing devices, one or more user signals descriptive of one or more user actions relative to one or more of the images in the cluster;
inferring, by the one or more computing devices, a quality metric for at least one image in the cluster based at least in part on the one or more user signals descriptive of the user actions relative to the images in the cluster;
generating, by the one or more computing devices, a label for at least one image of the cluster based at least in part on the quality metrics determined for the images in the cluster;
associating, by the one or more computing devices, the label generated for the at least one image with the at least one image in the cluster; and
storing, by the one or more computing devices, the labeled images and the respective labels generated for the labeled images in a training dataset.

22. (canceled)

23. A computing system comprising a machine-learned model, wherein the machine-learned model has been trained by performance of operations, the operations comprising:
obtaining, by one or more computing devices, a plurality of images;
grouping, by the one or more computing devices, each image in the plurality of images into one or more clusters based at least in part on a time metric; and
for at least one of the one or more clusters:
obtaining, by the one or more computing devices, one or more user signals descriptive of one or more user actions relative to one or more of the images in the cluster;
inferring, by the one or more computing devices, a quality metric for at least one image in the cluster based at least in part on the one or more user signals descriptive of the user actions relative to the images in the cluster;
generating, by the one or more computing devices, a label for at least one image of the cluster based at least in part on the quality metrics determined for the images in the cluster;
associating, by the one or more computing devices, the label generated for the at least one image with the at least one image in the cluster; and
storing, by the one or more computing devices, the labeled images and the respective labels generated for the labeled images in a training dataset.
